(19) United States
(12) Patent Application Publication
(10) Pub. No.: US 2016/0180022 A1
(43) Pub. Date: Jun. 23, 2016

(54) ABNORMAL BEHAVIOUR AND FRAUD DETECTION BASED ON ELECTRONIC MEDICAL RECORDS

(71) Applicant: FORTINET, INC., Sunnyvale, CA (US)

(72) Inventor: Pedro Miguel Paixao, Weston, FL (US)

(73) Assignee: FORTINET, INC., Sunnyvale, CA (US)

(21) Appl. No.: 14/574,760

(22) Filed: Dec. 18, 2014

(51) Int. Cl. G06F 19/00; G06F 21/62; H04L 29/06

(52) U.S. Cl. CPC G06F 19/322; H04L 63/20; G06F 21/6218

(57) ABSTRACT

Methods and systems for detecting and mitigating fraud by proactively analyzing and correlating Electronic Medical Record (EMR) audit log information in real-time are provided. According to one embodiment, activity information is received and queued in real-time as it is posted to audit logs of an EMR system onto a message queue of an EMR fraud and risk mitigation system. The activity information includes information regarding timing of an access to a database of multiple databases of the EMR system, a type of the access and a user initiating the access. The activity information is correlated and analyzed in real-time by one or more analysis models by dequeuing the activity information from the message queue and applying configurable rules maintained by a rules engine. The existence of one or more related events potentially indicative of fraud are detected based the results of the real-time correlation and analysis.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2014, Fortinet, Inc.

### BACKGROUND

1. Field

Embodiments of the present disclosure generally relate to electronic medical records (EMR) used in the healthcare industry. In particular, various embodiments of the present disclosure relate to systems and methods for detecting and mitigating fraud by proactively analyzing and correlating Electronic Medical Record (EMR) audit log information and/or network security events in real-time.

2. Description of the Related Art

The security of patient's health record is one of the increasing concerns being faced by hospitals, medical organizations, among other stakeholders in the medical industry. Unauthorized access to and/or fraudulent use of information within a patient's health records poses different risks, which impact different stakeholders in various ways, including the patients, hospital administrators, doctors, insurance agencies, and law enforcement agencies. In several parts of the world including the United States (US), Europe, and Canada, laws and government agencies impose an obligation on hospitals and medical organizations to maintain privacy of patients and protect patient's health records, giving rise to security issues while maintaining patient health information (PHI) in the form of an Electronic Medical Record (EMR), for example. While EMRs allows real-time record keeping and faster access the breadth of access provided to hospital employees, for example, results in data leaks, which facilitate perpetration of fraud.

The Health Insurance Portability and Accountability Act (HIPAA) of 1996 in the US requires establishment of national standards for electronic healthcare transactions, wherein healthcare providers are expected to implement security measures to ensure that electronically transmitted and electronically protected health information “is not improperly modified without detection until final disposal”. HIPAA also mandated that health care facilities retain the required documentation (including audit trail data) “for six years from the date of its creation.”

Though hospitals/healthcare providers were initially reluctant to invest sufficient capital on appropriate IT infrastructure to support EMR systems, they are now obligated to do so and the government provides financial aid for maintenance of such systems along with providing other incentives, which has lead to a massive increase in the adoption rate of EMR systems. The widespread adoption of EMR systems, however, has also given rise to the potential for healthcare fraud and/or unethical/undesired/bad behavior in relation to improper use of PHI records. For example, a fraudulent or authorized user can, in a few minutes, transfer digital medical records of thousands of patients from one location to another. Between 2009 and early 2012 alone, more than 18 million protected PHI records were compromised in the US. Data from last year also shows an increase of 32% in healthcare data breaches in the US. The stealing of Medicare beneficiary information by employees who have access to EMR systems and selling of such information to fraudulent providers is how most fraud is perpetrated.

Fraud and liability are some of the big drivers for healthcare costs throughout the world. In general, a medical fraud by a doctor includes prescribing unnecessary tests or over prescribing certain tests that are not required, performing unwanted procedures, prescribing unnecessary medication or false diagnostics to increase the billing, among other allied actions. Sometimes, doctors use defensive medical practices and prescribe unnecessary tests in an effort to protect themselves against malpractice liability. Other medical frauds include false billing by billing staff or false claims prepared and submitted to insurance agencies by the billing staff and/or by the hospital administration. It has been observed that sometimes, the billing staff, having access to patient's details, generate false billings and submit same for payment to insurance agencies with or without patients' knowledge/consent. An FBI report from May of 2012 indicates the United States spends more than $2.5 trillion on healthcare annually of which it is estimated that anywhere from 3% to 10% is attributed to fraud. This means the estimated annual cost of healthcare fraud ranges from $75 billion to $250 billion per annum in the US.

Medical data theft of unsecured electronic medical records, are giving further rise to the number of medical frauds, wherein a fraudulent user can now access and edit the patient's data that may put the patient at risk. For example, if the blood group or medicine reaction data of patient is changed, the patient may receive the wrong medication, worsening his/her health condition. The impact is even more serious when a person with criminal intent edits the patient's data using security loop holes in existing EMR systems.

In order to prevent and reduce such incidents, the Health Information Technology for Economic and Clinical Health Act (HITECH Act) was designed to “build trust in health information exchange”. The HITECH Act puts obligations on the hospitals and healthcare providers to maintain secure medical records, and also attaches various incentives provided by federal/state government with fulfillment of this security obligation.

In implementation, EMRs can be used differently by various stakeholders, wherein, for instance, it eases the way physicians practice medicine, correlate patient's history, lab reports, radiology image reports, etc. EMRs are also used by law enforcement agencies to discover and detect medical malpractice/fraud. During litigation, plaintiffs' or defendants' attorneys may seek to discover/access content of the medical records, audit logs, and access reports that are related to the EMR and created/maintained by hospital/healthcare providers. Further, these records are manipulated, organized, and sorted to generate chronologies that can be used to support their respective legal arguments. When hospitals, clinics, doctors' offices, or other medical facilities use electronic medical records, they are mandated by federal regulations to maintain a log that will identify individual(s) accessing the record(s), time and date of record access, record(s) accessed, portion(s) of the record accessed, and changes made if any, among monitoring other actions. Healthcare providers/hospitals are required by federal regulations to periodically audit their EMRs, and maintain a log for such activities, wherein audit trails include records of transactions in an electronic medical record (EMR) that provides verification of the activity on the system. The audit log must track information about who accessed the record, when the record was accessed, and indications about what was done. Audit data is primarily used for HIPAA security compliance, but could be discoverable in litigation. Use of the audit log and access report data includes the capability of detecting who accessed the EMR for any length of time, regardless of whether the same was recorded or not.

Another related issue being faced by hospitals/healthcare providers implementing EMRs is medical identity theft, which requires the EMRs to ensure the safeguard of medicare beneficiaries from potential harm that may be inflicted by identity theft and fraudulent employees. A patient whose medical identity has been stolen may suffer from a range of financial and social harms common to any type of identity theft. However, medical identity theft can also have life-threatening consequences. For instance, if a beneficiary's medical records are stolen and merged with another person record, the person whose medical records have been compromised can be at serious risk for medical consequences such as allergic reactions, improper medical treatment and/or refusal of needed medical services.

While health IT professionals are currently capable of performing after-the-fact analysis of EMR system audit logs after a patient reports a problem or error on their medical record or bill, for example, such post mortem analysis provides no upfront information that could be used to proactively identify or block a security breach. Hospitals, healthcare providers, government agencies, and insurance agencies have a need to prevent such frauds and put audit mechanisms in place, which can detect and prevent such frauds in real-time with the intent of trying to ensure that they do not re-occur. In addition, further problems exist in auditing and analyzing healthcare data as different sub-systems or modules implementing the EMRs use different data structures and databases. A variety of database management systems and EMR sub-systems are used by hospital and healthcare providers having varying capabilities. For example, there may be sub-systems such as labs module that use Oracle® as the underlying engine, and other sub-systems such as prescription management system that uses Focus® as the underlying engine. Meanwhile, a single user operation within an EMR system may read or write hundreds of record in multiple databases, thereby rendering useless traditional database security and compliance platforms that perform single database analysis.

There is therefore a need for a fraud and risk mitigation solution designed specifically for EMRs.

### SUMMARY

Methods and systems are described for detecting and mitigating fraud by proactively analyzing and correlating Electronic Medical Record (EMR) audit log information in real-time. According to one embodiment, activity information is received and queued in real-time as it is posted to audit logs of an Electronic Medical Record (EMR) system onto a message queue implemented by one or more computer systems of an EMR fraud and risk mitigation system. The activity information includes information regarding timing of an access to a database of multiple databases of the EMR system, a type of the access and a user initiating the access. The activity information is correlated and analyzed in real-time by one or more analysis models implemented by the one or more computer systems by dequeuing the activity information from the message queue and applying configurable rules maintained by a rules engine implemented by the one or more computer systems. The existence of one or more related events potentially indicative of fraud are detected based the results of the real-time correlation and analysis.

Other features of embodiments of the present invention will be apparent from the accompanying drawings and from the detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary patient data repository maintained by an Electronic Medical Record (EMR) system according to an embodiment of the present disclosure.

FIG. 2 illustrates an exemplary data record being recorded in an EMR system in accordance with an embodiment of the present disclosure.

FIG. 3 illustrates a view of patient record in accordance with an embodiment of the present disclosure.

FIGS. 4A and 4B illustrate exemplary representations of audit log(s) of user activity in relation to one or more EMRs in accordance with an embodiment of present disclosure.

FIG. 5 illustrates an exemplary process for detection, prevention and reporting of suspicious activity in an EMR system in accordance with an embodiment of the present disclosure.

FIGS. 6A and 6B conceptually illustrate an exemplary process for generation of a message queue based on one or a combination of audit logs in accordance with various embodiments of the present disclosure.

FIG. 7 illustrates an exemplary block diagram showing a network activity monitoring system in accordance with an embodiment of the present disclosure.

FIG. 8 illustrates an exemplary block diagram of event correlation in accordance with an embodiment of the present disclosure.

FIG. 9 illustrates an exemplary flow diagram of the proposed system in accordance with an embodiment of the present invention.

FIG. 10 is an example of a computer system 1000 with which embodiments of the present disclosure may be utilized.

### DETAILED DESCRIPTION

Methods and systems are described for detecting and mitigating fraud by proactively analyzing and correlating Electronic Medical Record (EMR) audit log information in real-time.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

While embodiments of the present invention are described in the context of fraud detection and mitigation, the methodologies and systems described herein are equally applicable to various other security events, including, but not limited to, information leaks, data breaches, record deletion and/or general hacking that can cause system crashes, affecting availability or data integrity.

In an aspect of the present disclosure, a method for detecting and mitigating fraud includes receiving and queuing in real-time onto a message queue implemented by one or more computer systems of an Electronic Medical Record (EMR) fraud and risk mitigation system, activity information as it is posted to multiple audit logs of an EMR system, wherein the activity information includes information regarding timing of an access to a database of multiple databases of the EMR system, a type of the access, and a user initiating the access. The method further includes correlating and analyzing in real-time, by one or more analysis models implemented by the one or more computer systems, the activity information by dequeuing the activity information from the message queue and applying configurable rules maintained by a rules engine implemented by the one or more computer systems for detecting, based on said correlating and analyzing, existence of one or more related events potentially indicative of fraud.

According to one embodiment, correlating and analyzing the received/queued activity information can include extracting analytics and statistical data based on a subset of the activity information. According to another embodiment, the message queue can be configured to enable processing of activity information in proper temporal order. According to another embodiment, method of the present disclosure can further include aggregating information regarding one or more observed events to generate analytics and statistical data.

According to another embodiment, the method for detecting and mitigating fraud further includes using at least one rule from the rule engine that is defined in real-time based on the one or more events associated with the at least one audit log. The method can further include automatically defining at least one rule of the configurable rules maintained by the rule engine based on the extracted analytics and statistical data. According to another embodiment, at least one rule of the configurable rules maintained by the rules engine can be defined based on a learning-based anomaly detection model that is configured to dynamically determine one or more thresholds of acceptable behavior for particular activities in relation to the EMR system. According to another embodiment, at least one rule of the configurable rules maintained by the rules engine can be defined based on one or a combination of a predictive model and a social network analysis model.

According to another embodiment, an EMR fraud and risk mitigation system includes a message queue implemented by one or more computer systems configured to, in real-time, receive and queue activity information as it is posted to multiple audit logs. The system can further include a rules engine implemented by the one or more computer systems configured to create, store, and manage multiple rules, and can further include a processing engine implemented by the one or more computer systems configured to detect one or more related events potentially indicative of fraud by retrieving activity information from the message queue, correlating the activity information, and applying one or more of the rules of to the correlated activity information.

According to one embodiment, the EMR fraud and risk mitigation system can further include an analytics engine configured to store analytics and statistical data relating to the activity information.

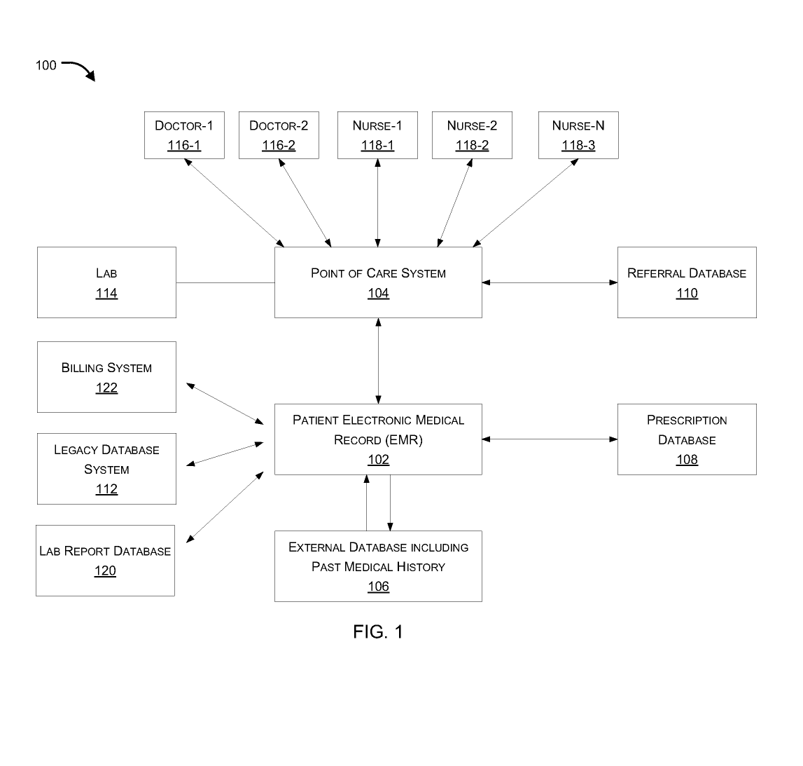

FIG. 1 illustrates an exemplary architecture 100 incorporating an electronic medical record (EMR) 102 of a patient where the EMR is operatively coupled to multiple repositories/databases that store activity logs of actions conducted by one or more users/stakeholders according to an embodiment of the present disclosure. In the context of the present example, patient electronic medical record 102 (also commonly referred to as simply an EMR) can be integrated/connected with multiple modules and database(s) that enable creation, storage, retrieval of log data on/from one or more computer system/databases. Databases that store patient/hospital data may also be used in connection with event analysis. For instance, if a patient had no appointments in the last 15 days event analysis raise an issue if new tests are being ordered. Access to such data can be done directly via the database or through EMR vendor APIs. In some embodiments, the implementation may rely on log information only; however, other embodiments may use APIs and direct database access to obtain certain types of events that may not be logged in the audit logs.

As shown in FIG. 1, EMR 102 can be connected to a point of care system 104, which may also referred to hereinafter as point of care terminal or PoC terminal(s) 104, and one or more external databases that can include past medical history of one or more patients, which may also be referred to as external database(s) 106 hereinafter. According to one embodiment, PoC terminal(s) 104 can be configured to provide different services to different stakeholders/users. For instance, a single or multiple terminals/systems 104 can be used by one or more users including but not limited to, labs 114, doctors 116, nurses 118, and referral database 110, among other users/stakeholders such as insurance companies, for accessing and/or evaluating/processing EMR record 102. For instance, labs 114 can use EMR 102 in order to generate one or more reports, which can then be stored in say a lab report database 120. Similarly, doctors, such as 116-1 and 116-2, which may be collectively referred to as doctors 116 hereinafter, can access EMR 102 through terminal/system 104 to monitor patient progress, issue prescriptions, among other activities, wherein, the prescriptions can, say be stored in a prescription database such as 108.

In an embodiment, access to EMR 102 and all activities performed by one or more stakeholders, including, but not limited to, accessing EMR 102, viewing of EMR 102, addition/deletion of information to/from EMR 102, merging of records, modification of records, update of records, etc., can be captured and stored in real-time within one or more databases, which may also be interchangeably referred to as audit logs hereinafter. In an embodiment, EMR 102 can also be connected/integrated with one or more databases and/or sub-systems such as billing system 122, legacy database system 112, lab report database 120, and prescription database 108. Those skilled in the art will appreciate that these databases and sub-systems are merely for purposes of illustration, and incorporation of more or fewer structures/functional modules/databases/repositories is within the scope of the present disclosure. Alternative embodiments of the present disclosure are further intended to cover integration of other modules/sub-systems/databases related to patient information and medical history, physical access control systems, electronic access control system and drug databases.

According to one embodiment, the format, type and/or content of EMR 102 can vary for each patient and different rights can be accorded to users in relation to access, modification and processing of EMR 102. For instance, a doctor 116 may be given all rights to access and modify EMR 102 but may not be allowed to delete EMR 102. Similarly, nurses may only be given the rights to update prescription details, patient behavior, and other like content, without being able to amend/delete any existing content. Therefore, different rights can be given to each user depending on their respective responsibilities and roles. Apart from actions, rights can also be granted based on the type/section/portion of data/content of EMR 102 that the one or more users are entitled to view/change/modify.

According to one embodiment, activities performed by one or more users/stakeholders in relation to EMR 102 can be recorded/posted/stored in one or more audit logs that are configured to store/manage/process/evaluate one or more actions/activities performed by one or more users/stakeholders that access/delete/modify/manage EMRs. For instance, a first audit log can be created for actions performed by the lab, a second audit log can be created for actions performed by the billing section, a third audit log can be created for actions performed by doctors, and so on. Alternatively, a single audit log can also be created and managed in a database so as to easily enable retrieval of actions taken by one or more users, time of such actions, type of actions, effect of actions, changes in database/repository, among other like parameters/factors. According to one embodiment, instead of recording all actions/activities, only a configurable and/or pre-defined set of activities are logged/stored in the audit log. For instance, only content modification related actions may be logged and not actions that relate to creation of new patient data or addition to existing data. Such configurations can be defined for one or more users and/or categories or users.

According to one embodiment, architecture 100 is operatively coupled with an Electronic Medical Record (EMR) fraud and risk mitigation system, which can include one or more computer systems to access, monitor, process, and evaluate one or more audit logs to receive and queue, in real-time, onto a message queue, activity information as it is posted to the audit logs, wherein the activity information can include, but is not limited to, information regarding timing of an access to a database of multiple databases of the EMR system, a type of the access and/or a user initiating the access.

According to an embodiment, the received/queued activity information can be correlated and/or analyzed in real-time by one or more analysis models implemented by the one or more computer systems, wherein, in an implementation, the activity information can be dequeued from the message queue, and one or more rules maintained by a rules engine implemented by the one or more computer systems can be applied such that based on the output from the correlation and analysis, existence of one or more related events potentially indicative of fraud can be identified.

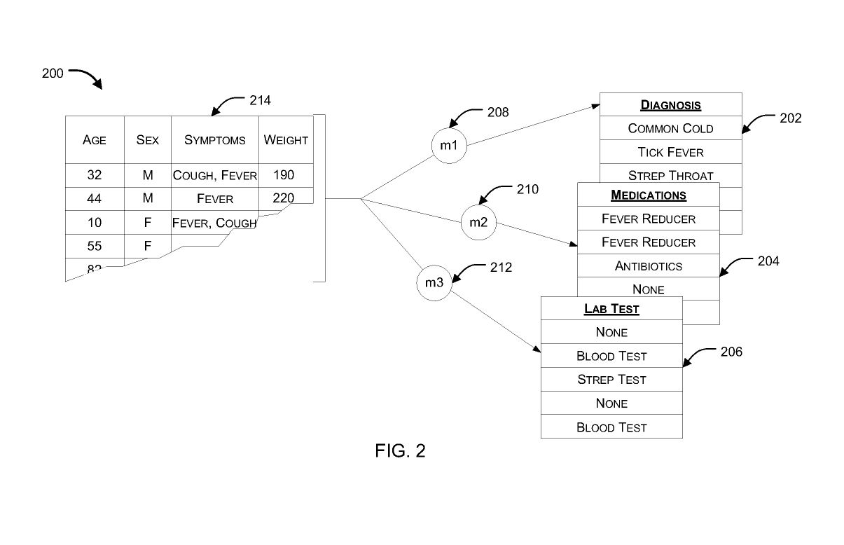

FIG. 2 illustrates exemplary data records being recorded for one or more patients in an EMR system in accordance with an embodiment of the present disclosure. In an aspect, patient data including, but not limited to, lab reports, prescriptions, allergy information, images, hospitalization records, discharge summaries, nurses' notes, and medication data, among other like information, can be recorded and stored in a single or multiple databases that form part of an EMR, and can be accessed by various stakeholders, as mentioned above with reference to FIG. 1, based on the authorization given by the EMR system.

FIG. 2 shows an exemplary table of databases that store basic information about patient for quick assessment of patient's record. As illustrated in FIG. 2, a record table 214 can include data such as age, sex, symptom, weight, unique hospital ID (UHID), name, location, indication of OPD/IPD, etc. Against each patient/UHID, there may be multiple associated records that can be accessed by different stakeholders. Non-limiting examples of records that might be associated with a patient/UHID include a table of diagnosis 202, medications 204, and lab reports 206 that can be categorically stored/explored respectively through links m1 208, m2 210, and m3 212.

In an aspect, record 214 can store input data for different patients, and provide hyperlinks/logical links to related databases that can provide different categorized records associated with one or more patients/UHID's. Record 214 can further maintain or dynamically create relationships between the input data and the actual results of diagnosis 202, medications 204, and lab-tests 206. In an exemplary embodiment, record 214 may use statistical regression techniques, such as parametric and semi-parametric regression to discover relationships between the data obtained from and about patients from different databases such as from medication database, lab database etc. In discovering these relationships, various combinations of input and output data fields are passed through multiple regression engines implemented, for example, at different servers/computer terminals.

When a user and/or a stakeholder of the EMR system tries to access record 214, he/she may get different sets of data/information based on the access rights they have. When an authorized user, for example, a nurse tries to access the record 214 for a limited set of patient data (say 5-10 patients), the same may be allowed, but when the same nurse 214 tries to access and/or copy/modify/process the same dataset for thousands of patients (say 1000 patients) within a matter of few seconds/minutes, the system may classify such activity as being malicious as explained in further detail below. Similarly, when the billing staff wishes to edit, merge, and/or delete any record pertaining to a patient's medical record, such events can be detected and reported by the proposed system of the present disclosure. In an embodiment of the present disclosure, an EMR fraud detection system can be configured to raise an alarm/flag whenever unauthorized personnel attempt to edit/modify/delete/access/process record(s) of one or more patients.

According to one embodiment, EMR of FIG. 2, when accessed by one or more users, can lead to generation of one or more entries in one or more audit logs that can be stored in one or more repositories/databases, wherein the audit logs can be configured/recorded based on actions/activities conducted by the users on the EMRs of one or more patients, and can include information regarding a type of action, an activity performed, a timestamp, a user name or other identifying information regarding the user associated with the activity, number of EMRs accessed, type/portion of content accessed, among other like parameters/attributes. Actions that are logged as part of the audit log can be configured in real-time so that only the desired set of actions are captured. Alternatively, all actions can be logged.

According to one embodiment, the EMR fraud detection system can include a message queue that, in real-time, can be configured to receive and/or queue activity information as it is posted to (or recorded/stored in) one or more audit logs of an EMR system. The EMR fraud detection system can further include a rules engine that is configured to create, store, and manage multiple rules, and can further include a processing engine configured to detect one or more related events potentially indicative of fraud by retrieving activity information from the message queue, correlating the activity information, and applying one or more of the rules to the correlated activity information. Therefore, based on the analysis of the activity information that forms part of one or more audit logs in view of one or more defined/configured rules, events that are potentially indicative of fraud can be determined/identified.

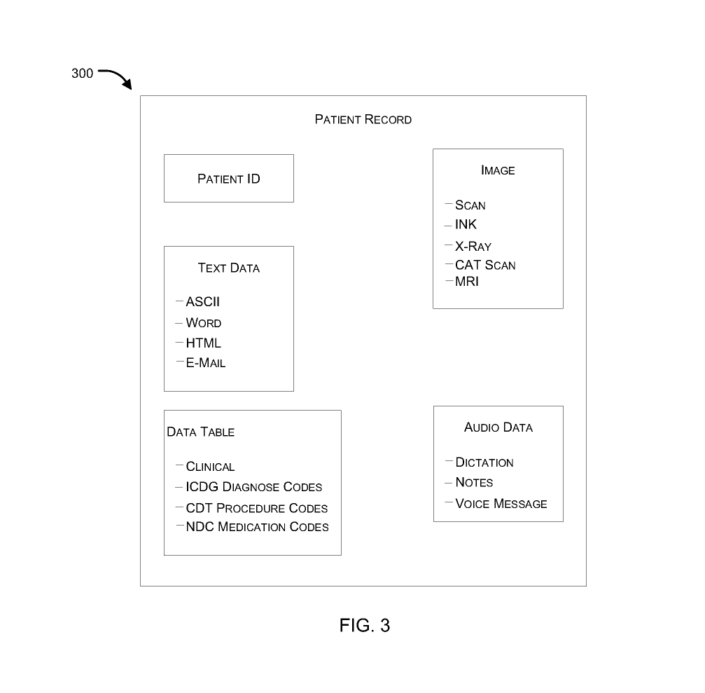

FIG. 3 illustrates an exemplary view of a patient record 300 in accordance with an embodiment of the present disclosure. As illustrated in FIG. 3, a typical patent record page created from an extract of data available within EMR can be displayed. Each user may have a unique hospital and/or patient ID that can, for instance, be an alphanumeric value and which can uniquely identify a patient and can be used in the database as unique key to link different data available with different databases. A typical patient record page may also include/incorporate images, including, but not limited to, a scanned/digital image of the patient to visually recognize/co-relate their lab reports, x-rays, CT-scans, CAT scans, MRI scans and other images representing patient's physical conditions and radiography and ultrasound images. Record page 300 can also store data related to the patient in other formats such as such as ASCII, Word, HTML, E-mail and other suitable formats that may be accessed by various stakeholders through hyperlinks or logical/links or through database queries. In an embodiment of the present disclosure, the data in the underlying databases may be stored in an encrypted form. In an embodiment, the EMR system can also maintain and track one or more data tables such as clinical data table, ICDG Diagnose code, CDT procedure code, and NDC medication codes. In an embodiment, EMR of the present disclosure can also maintain and track access of audio data and video data such as dictation, notes, and voice messages by doctors, nurses, patients and attendants. In an example implementation, video of performed procedures, operators, CCTV footage of doctor patient interaction, CCTV footage of patient, CCTV footage of Operation Theater (OT) procedure(s) can also be recorded and linked with patient's database with appropriate or enhanced security level. Those skilled in the art will appreciate that the various types of data described herein are completely exemplary, and has been listed merely for illustration purposes only, and not meant to be restrictive or limiting.

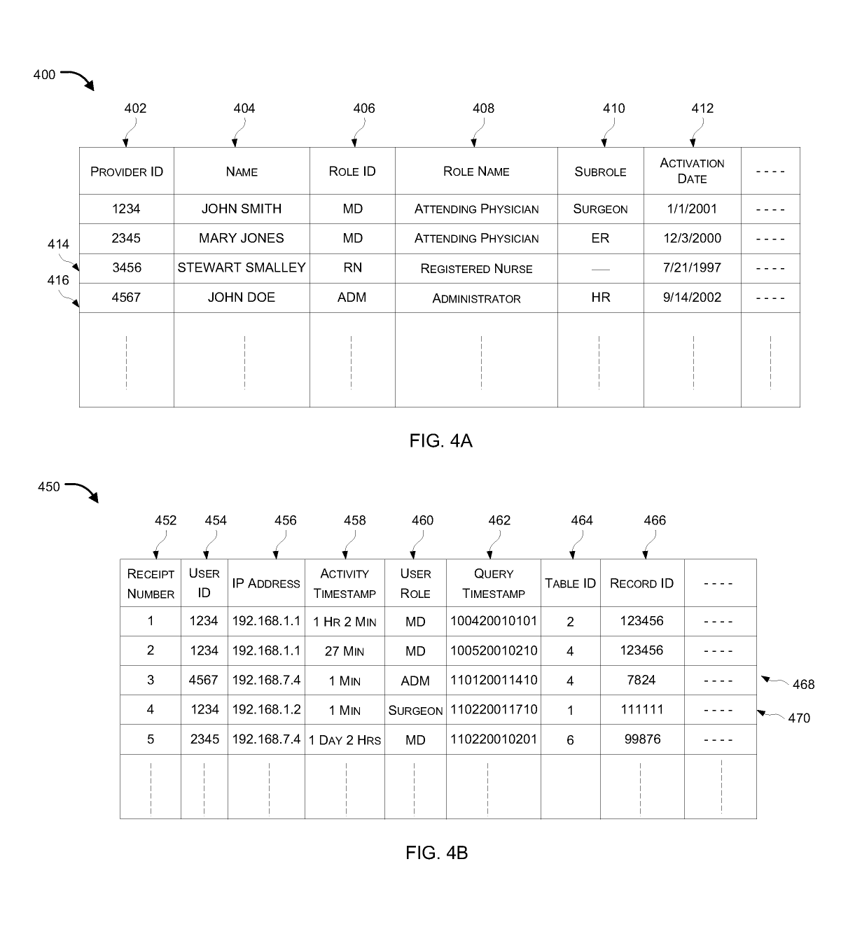

FIGS. 4A and 4B illustrate exemplary representations 400 and 450 of audit log(s) of user activity in relation to one or more EMRs in accordance with an embodiment of present disclosure. According to one embodiment, audit logs can be created/updated/maintained whenever data for patient(s) is created, accessed, edited, deleted, or any other action is performed by one or more users, such as nurses, insurance agencies, doctors, surgeons, among other users depending on the authorization given to them by the system. Such audit logs can, in an implementation, be stored on one or a combination of databases and/or repositories, wherein, for instance, multiple audit logs can be created depending on the records being accessed, users accessing the records, the activity being performed, among other parameters. For instance, a single audit log may be created for all EMRs accessed/processed by doctors, and another audit log can be created for EMRs accessed/processed by the lab. That is, the log can be created based on the type of user. In another instance, a specific audit log can be created for each user. In another instance, audit logs can be created based on the type of activity being performed, say modification/editing/addition/deletion of records. In yet another instance, audit logs can be generated based on type or source of records being accessed, say patient medical history information, patient test results, among other like attributes that form part of the type of content being accessed from the EMR.

FIG. 4A shows an exemplary audit log 400 having fields, such as provider ID 402, name of the user 404 accessing one or more EMRs, role ID 406 of the user accessing the EMRs, a role name 408 providing details of the role of the user, a sub-role 410 of the user accessing the EMR (if any), and an activation date 412 of the user's account within the system. Rows 414 and 416 show exemplary audit log entries for two users.

In FIG. 4B, on the other hand, audit log 450 shows more details of the activities performed by the users and attributes relating to such actions. For instance, log 450 shows the fields including a receipt number 452, a user identifier/ID 454, an IP Address 456 of the user accessing the EMR, a timestamp 458 of when the activity is performed by the user, a user role 460, a timestamp 462 of when the user issued the query to the database to access/process EMR, a table ID 464 identifying from where the EMR data/content was accessed, a record ID 466 of the EMR being accessed, among other like parameters/fields such as type of action performed, actual action performed, impact of such activity on the integrity of the EMR and on the system in general, duration of access/processing of one or more EMRs, frequency of such actions, among other like parameters/fields. Rows 468 and 470 show exemplary actions performed by different users, wherein, in view of row 468, user ID 4567 (of John Doe of FIG. 1) accessed one or more EMRs from IP address 192.168.7.4 for 1 minute, wherein at least one query was issued by the user at timestamp 110120011410, wherein the user having user ID 4567 accessed table ID 4 and record 7824 of the EMR database.

Those skilled in the art will appreciate that the present representation is completely exemplary in nature, and any other modes of representation of the audit log are completely within the scope of the present disclosure. For instance, multiple audit logs may be used as mentioned above. Each audit log can further include multiple other fields such as the action undertaken by the respective user, the impact of such action on the EMR being accessed and on the system in general, frequency of actions, user background of violation, among other fields, which can be analyzed based on certain one or more rules defined by a rule engine to identify a potential fraudulent activity.

As also mentioned above, in an exemplary implementation, the audit logs can be configured to store different sets of data in different databases, wherein, for instance, a billing database can be configured to store the billing audit log that stores actions/activities taken by one or more users on the billing section of the EMR. Similarly, a prescription database can be configured to store the prescription audit log that stores actions/activities taken by one or more users on the prescription section of the EMR. In another example, a test result database can be configured to store the test result audit log that stores actions/activities taken by one or more users on the test results section of the EMR. Likewise, many other audit logs relating to actions on lab records, prescriptions, bibliographic details, referrals, medications, can be stored in respective databases/repositories. In an alternate embodiment, a single audit log can also be generated having a list of all the actions being taken by the user. In yet another embodiment therefore, a separate log server can maintain log history for all transactions involving different sub-systems and databases of EMR management system.

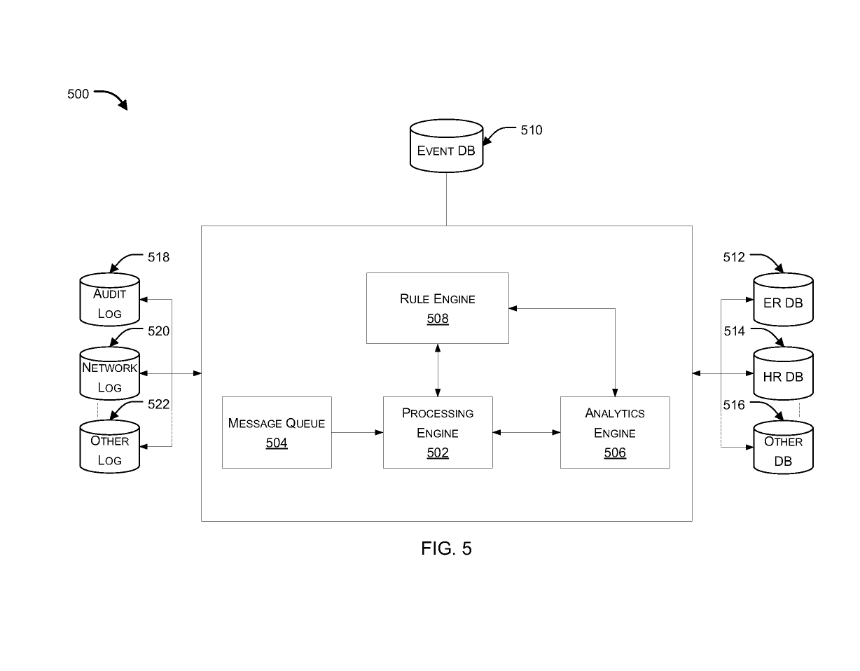

FIG. 5 illustrates an exemplary architecture of a system configured on one or more computer/servers for detection and prevention of suspicious activity using an EMR system in accordance with an embodiment of the present disclosure. As illustrated in FIG. 5, the system can include a message queue 504, a processing engine 502, an analytics engine 506, and a rule engine 508. According to one embodiment, the message queue 504 can be implemented by one or more computer systems and can be configured to receive and queue, for instance in real-time, activity information as it is posted to multiple audit logs 518 of an EMR system. As disclosed above, audit logs 518 can include one or more logs that define the activities/actions performed on EMRs by one or more users. In an embodiment, the activity information can be filtered before being received/queued at the message queue 504, if desired, based on a certain time range, users in context, departments to which the users belong, or any other conceivable parameter(s)/criteria/attribute(s). According to one embodiment, as audit logs can be stored within different databases depending on say the user in context, action performed, records being processed/accessed, the message queue 504 can be operatively coupled with all or part of such databases to receive the activity information in real-time from these databases. As mentioned above, any number of filtering criteria can be configured before the activity information is received/queued at the message queue 504.

According to another embodiment, the rule(s) engine 508 can be implemented by the one or more computer systems (not shown) and can be configured to create, store, and manage multiple rules, wherein the processing engine 502 can be implemented by the one or more computer systems and can be configured to detect one or more related events potentially indicative of fraud by retrieving activity information from the message queue 504, correlating the activity information and applying one or more of the rules to the correlated activity information. Depending upon the particular implementation, rules engine 508 can dynamically create one or more of the rules at run-time, rules can be configured by an administrator and stored in a repository, wherein one or more appropriate rule(s) can be selected by the engine 508 and based on the activity information such that the selected rules can then be used to process the queued activity information and determine correlated activity information that is indicative of potential frauds.

In an implementation, for instance, when the queued activity information from one or more audit logs relates to actions performed by the billing department, rules pertaining to the billing department such as one attempting to retrieve information on number of records accessed, actions performed on one or more bills, list of changes performed in the billing parameters, changes in rates, among other like rules can be incorporated/processed for determining the correlated activity information that is indicative of billing related fraud. As such activity information is being retrieved in real-time, any deviation from the expectation ranges with respect to one or more defined rules can be raised in real-time itself without waiting for the billing relating actions to be completed.

According to another embodiment, message queue 504 can be configured to enable processing of activity information in proper temporal order. In another embodiment, one or more rules can be defined by/in rules engine 508 in real-time based on the one or more related events. In another embodiment, one or more rules can be defined by/in rules engine 508 automatically based on the analytics and statistical information obtained from analytics engine 506. In yet another embodiment, one or more rules can be defined by/in rules engine 508 based on a learning-based anomaly detection model that is configured to dynamically determine one or more thresholds of acceptable behavior for particular activities in relation to the EMR system. In yet another embodiment, one or more rules can be defined by/in rules engine 508 based on one or a combination of predictive models and social network analysis models.

According to one embodiment, analytics engine 506 can be configured to store analytics and statistical data relating to the activity information, wherein the analytics and statistical data is obtained after execution of the activity information by processing engine 502 based on one or more analysis models implemented on one or more computer systems. Processing engine 502, in an exemplary implementation, can de-queue the activity information from message queue 504 and apply one or more configurable rules maintained by rule engine 508. In an implementation, system 500 of the present disclosure can detect, based on the analytics and statistical data stored in analytics engine 506, existence of one or more related events that may be potential indicators of fraud. In another embodiment, an event database 510 can be configured to store the one or more potential events that may be indicative of fraud, or can also be configured to store any other information relating to events arising out of the activity information queued within message queue 504.

According to another embodiment, system 500 can further include additional information such as network level information from network logs 520, wherein the network information can be correlated with the users involved, their actions, frequency of actions, records being accessed, impact of such actions on the EMR in context, among other like attributes. For instance, network log 520 can present each user with respect to its IP address, protocol being used, databases being accessed, timestamp of such access, queries being issued, among other like parameters, which can be correlated with the activity information obtained from audit logs 518 to be eventually processed in view of the relevant rules from rule engine 508 to identify potential events indicative of fraud and/or improper access. In alternative embodiments, logs from other security devices, e.g., firewalls, Intrusion Prevention System (IPS), Antivirus (AV), Advanced Persistent Threat (APT), Sandbox, email security, web filters, DoS and others may be used to provide a more complete picture of the security environment that surrounds the EMR system. As such, this additional information may facilitate detection of fraud and/or irregular access. In one embodiment, system 500 correlates network security events, which may be detected by various network security devices and gateways, with EMR audit logs. Such information provides an unprecedented view into the true behavior of users. For example, correlation data revealing a user always sends emails to his/her private account after printing EMR records may be an indicator of improper use of EMR records. Another example indicative of potential fraudulent and/or improper access would be a high volume of accesses to the EMR system from a computer for which an AV and/or APT engine within a network security appliance, e.g., a FORTIGATE gateway, detected some attack attempts in previous hours, or days. Such correlated information may indicate that the computer at issue has been compromised and now is being used to extract EMR information.

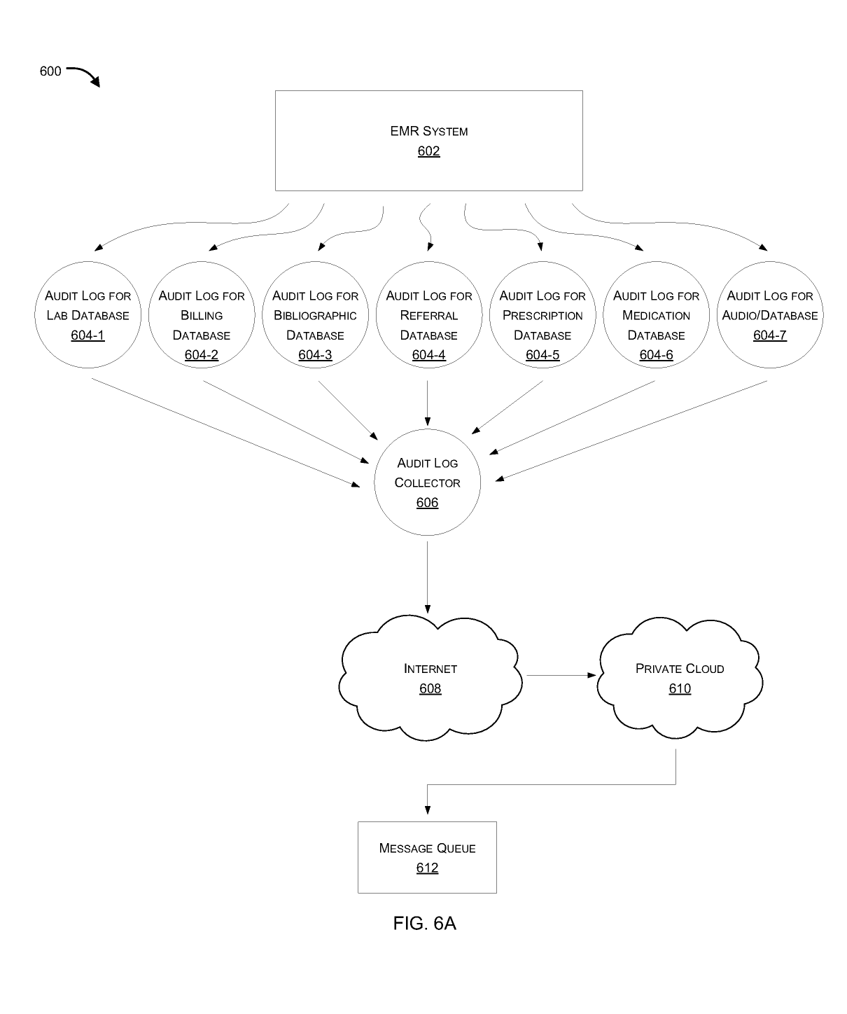

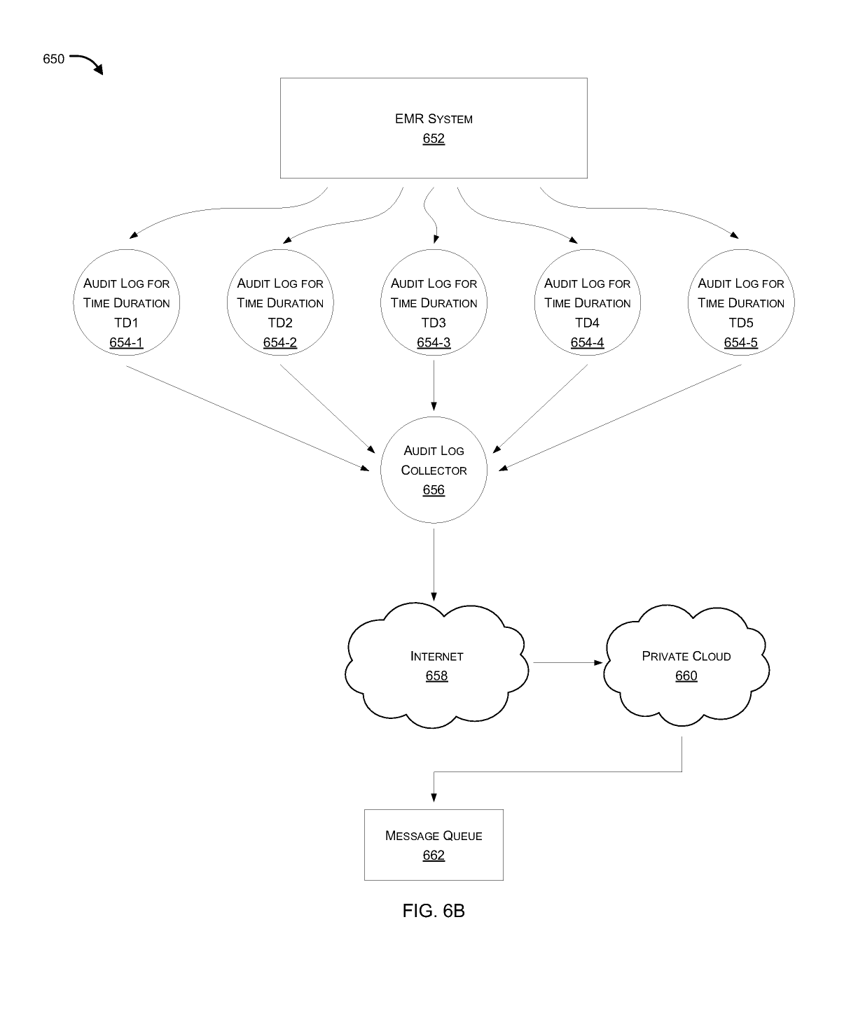

FIGS. 6A and 6B conceptually illustrate an exemplary process for generation of a message queue 612 based on one or a combination of audit logs 604 in accordance with various embodiments of the present disclosure. As shown in FIG. 6A, message queue 612 can be generated by the proposed system 602 based on one or a combination audit logs 604 that are indicative of actions/activities performed by one or more users of the EMR system 602, wherein the audit logs 604 can either be stored in a single database or in a combination of multiple databases. Audit logs 604 can also be specific to, for instance, the department responsible for making changes to or processing one or more EMRs of patients. For instance, as shown in FIG. 6A, separate audit logs can be created for activities relating to lab results and stored in lab database 604-1, for activities relating to billing information and stored in billing database 604-2, for activities relating to bibliographic details and stored in bibliographic database 604-3, for activities relating to referral information and stored in referral database 604-4, and so on, wherein one or more audit logs can be stored on one or a combination of databases. Those skilled in the art will appreciate that the audit logs may include all actions taken by one or more users or only a defined set of actions may be logged, wherein such actions can be pre-configured or can be determined in real-time based one or more criteria defined by the moderator/administrator of the system. Furthermore, although audit logs 604 of FIG. 6A have been shown with reference to different departments that can access an EMR, any other construction for segregation of audit logs is completely within the scope of the present disclosure. For instance, parts of an EMR being accessed can be used as another parameter to construct different audit logs.

As shown, in an implementation, all or part of the logs from databases 604 can be processed to extract the activity information, which can be collected at an audit log collector 606 and then sent over a network say Internet 608 to an exemplary private cloud such as 610 that can take the temporally arranged audit logs to construct/generate the message queue 612. According to one embodiment, activity information can be extracted from the logs based on one or more conditions such as time range, type of activity, impact of activity, record(s) being accessed, users involved, among other like conditions. Therefore, the activity information received and queued at the message queue 612 may represent a subset of that which has been posted to multiple audit logs of an EMR system, wherein the activity information may include information regarding timing of access to the corresponding database of multiple databases of the EMR system, a type of the access and a user initiating the access. Such queued activity information can then be correlated and analyzed in real-time by one or more analysis models implemented by the one or more computer systems by dequeuing the activity information from message queue 612 and applying configurable rules maintained by a rules engine implemented by the one or more computer systems, based on which existence of one or more related events potentially indicative of fraud can be detected. According to one embodiment, the message queue can be configured to enable processing of activity information in proper temporal order and in real-time.

FIG. 6B illustrates an alternate embodiment of the above-mentioned architecture for generation of a message queue 662, wherein message queue 662 can be generated from one or more audit logs 654 that are obtained based on time durations. For instance, an audit log can be generated periodically (e.g., every 5 hours, 5 days, 5 minutes, or any other configuration depicting the time interval of different events/activities). Any other mode of generation of audit logs is therefore completely within the scope of the present disclosure.

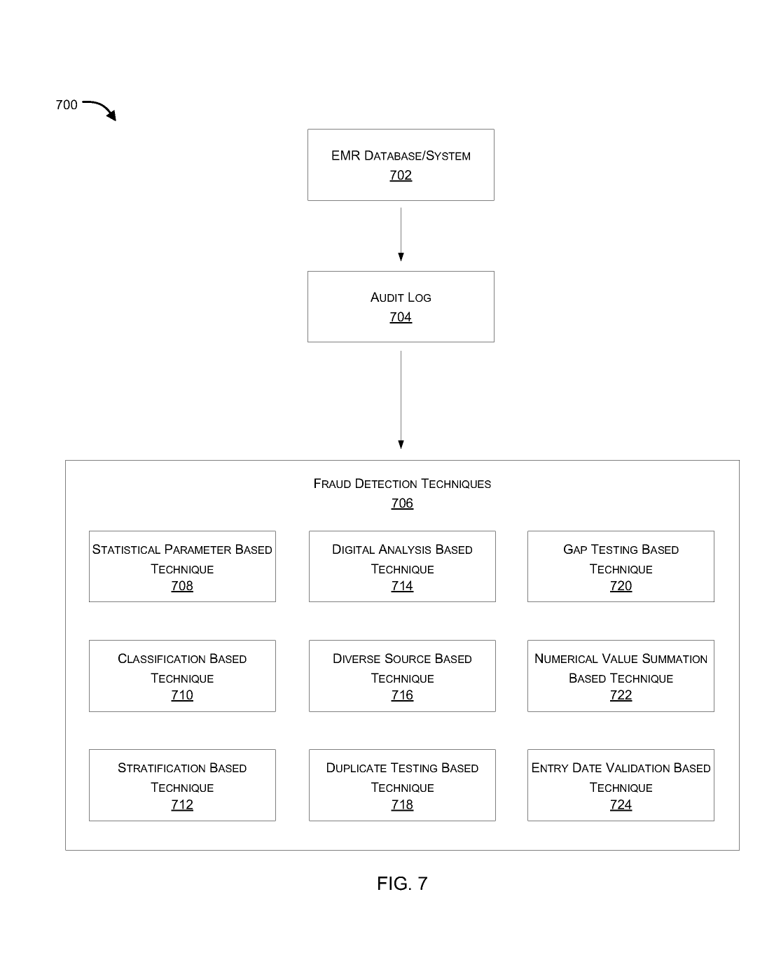

FIG. 7 conceptually illustrates an exemplary representation 700 showing real-time queuing of events posted to multiple audit logs of an EMR system 702 and being processed by different fraud and/or security detection techniques 706 in accordance with an embodiment of the present disclosure. As shown in FIG. 7, one or more fraud detection techniques 706 can be applied to one or more audit logs 704 from the EMR database/system 702, wherein the techniques 706 can either be pre-selected or can be identified at run-time depending on the audit log in context and the activity information contained therein. Fraud detection techniques 706 can, as a result, receive, process, analyze, and correlate audit log 704 in view of the activity information therein to proactively detect potential fraud in relation to the use of the EMR system 702. In an example implementation, different techniques can be used for analyzing event logs, correlating the events logs, and dynamically defining parameters for detection of fraud in real time.

In an aspect, exemplary techniques for detection of fraud in real-time in EMR system 702 can include, but are not limited to, a statistical parameter based technique 708, a classification based technique 710, a stratification based technique 712, a digital analysis based technique 714, a diverse source based technique 716, a duplicate testing based technique 718, a gap testing based technique 720, a numerical value summation based technique 722, and a entry date validation based technique 724. One or more of these techniques can be used alone or in combination with other(s) to analyze, correlate and detect potential frauds in the EMR system. In an exemplary implementation, fraud detection techniques 706 can be used to dynamically determine and define one or more parameters that can be used by EMR system to proactively detect frauds in the EMR system. Furthermore, one or more fraud detection techniques 706 of present disclosure can use these dynamically determined one or more parameters to proactively detect fraud in EMR system.

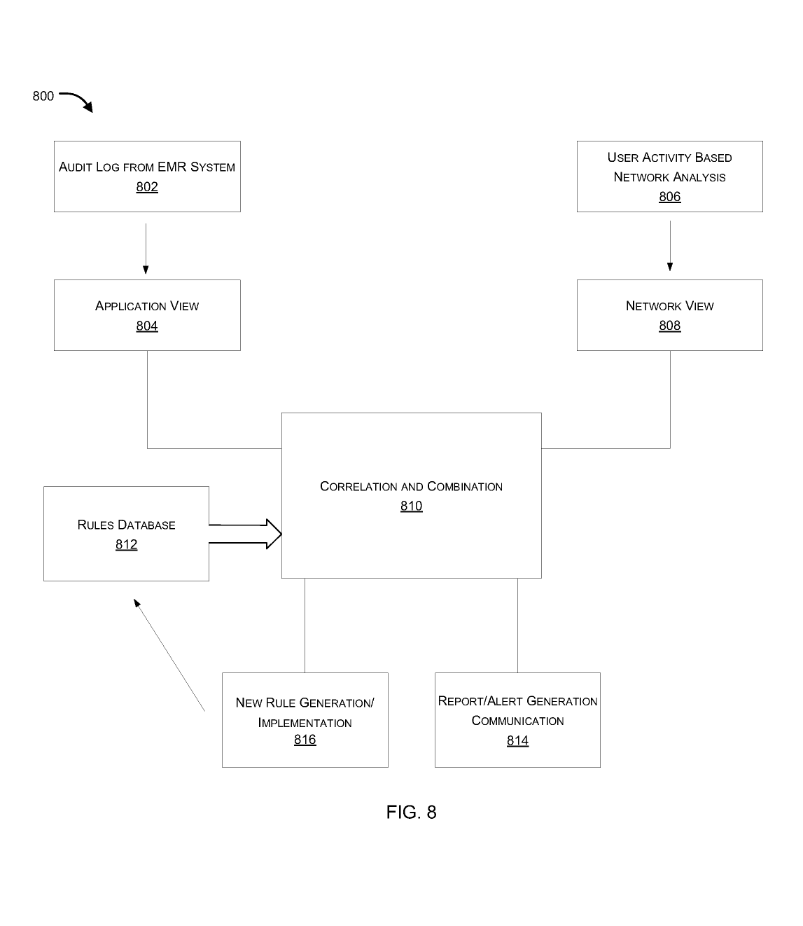

FIG. 8 illustrates an exemplary block diagram of EMR fraud and risk mitigation system 800 in accordance with an embodiment of the present disclosure. In the context of the present example, system 800 can include an application view 804 and a network view 808, wherein the application view 804 can be configured to receive activity information relating to one or more users, network hardware, applications, or servers, in relation to EMRs based on one or more audit logs 802, and network view 808 can be configured to assess the network-level activity (such IP addresses of the users, amount of data/content uploaded/downloaded, emails sent, network level applications used, among any other network level information) of the same set of one or more users (including other users, if desired). The activity information from EMR audit logs and the network analysis results can then be correlated and combined by a correlation and combination module 810 based on one or more rules of a rules database/engine 812 to result in one or more alerts of potential fraudulent events. According to one embodiment, one or more new rules 816 can also be generated/implemented dynamically based on the activity information and/or the network activity information of one or more users, and such one or more new rules can then be stored/updated in rules database 812.

In an exemplary implementation, application view 804 can be configured to provide a man-machine interface for interaction between a user and the system for giving various commands and instructions and to collect or filter out all the details associated with application level log from the EMR system or database. In an embodiment, EMR fraud and risk mitigation system 800 can also perform user activity based network analysis 806 to monitor routine and normal activities and detect any suspicious network activity, e.g., transfer of large amount of data or uploading and loading of an unauthorized data set or unauthorized manipulation of data, etc. Any suspicious network activity, for example, attempt to access or tamper with the billing system or tampering with any other database or unauthorized access to databases, etc., can be detected by EMR fraud and risk detection and mitigation system 800. In an example implementation, network view 808 can be provided by EMR fraud and risk detection and mitigation system 800. In an embodiment, one or more application view logs 804 and one or more network view logs and/or security logs 808, that is application-level logs and network-level logs, can be collected by correlation and combination module 810, which further analyzes, correlates, and combines logs from different sources and applies one or more rules retrieved from rules database 812. According to one embodiment, network view 808 collects information about devices, as well as users. For example, features like automatic device detection, or reputation included within FORTIGATE gateway products, for example, allow for the creation of dynamic rules that are user-based and/or device-based. Such rules are useful in connection with detecting bots, infected computers, servers etc.

In an example implementation, EMR fraud & risk detection and mitigation system 800 can also include a new rule generation/implementation module 816 that can provide flexibility to EMR fraud & risk detection and mitigation system 800 so as to allow creation of new parameters and/or rules and/or means to define fraudulent actions or potential fraud activities. In an example implementation, new rule generation/implementation module 816 can use one or more automatic techniques to dynamically define new rules configured for fraud detection based on log data correlation and analysis performed by correlation and combination module 810. In an embodiment, correlation and combination module 810 can collect log data from different sources such as application level logs of different sub-systems/databases of EMR, and network level logs, and correlate them to determine one or more suspicious activity.

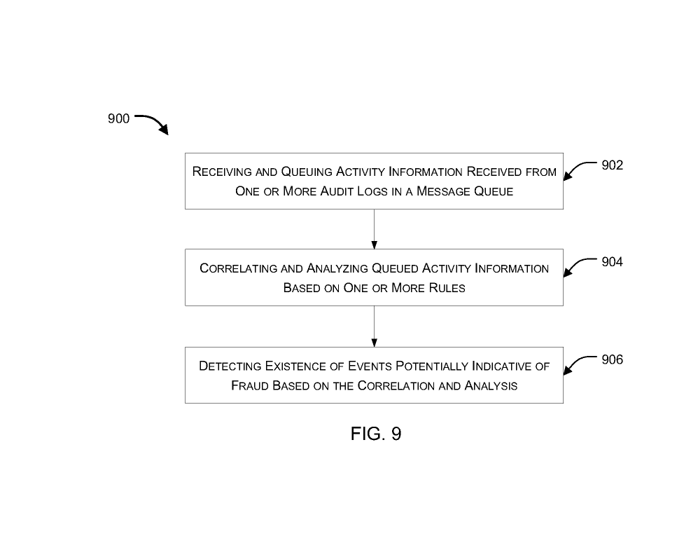

FIG. 9 illustrates a flow diagram 900 for implementation of an EMR fraud and risk detection and mitigation system in accordance with an embodiment of the present disclosure. At step 902, the method includes receiving and queuing, in real-time, onto a message queue, activity information as it is posted to multiple audit logs of an EMR system, wherein the activity information can include information regarding timing of an access to a database of multiple databases of the EMR system, a type of the access and a user initiating the access. At step 904, the method includes correlating and analyzing in real-time, by one or more analysis models, the activity information by dequeuing the activity information from the message queue and applying configurable rules maintained by a rules engine. At step 906, the method comprises detecting, based on the correlating and analyzing, existence of one or more related events potentially indicative of fraud. According to one embodiment, the step of correlating and analyzing can include extracting analytics and statistical data based on a subset of the activity information.

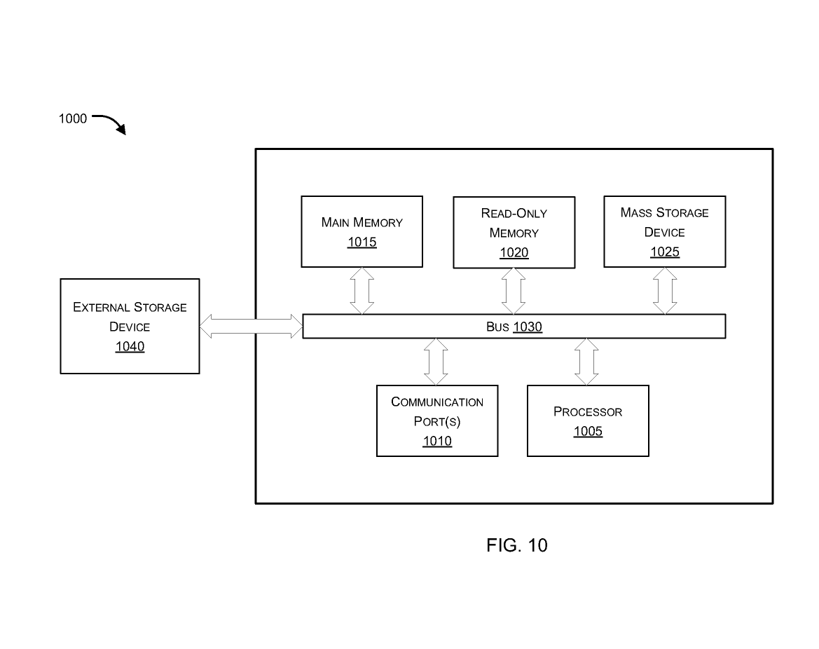

FIG. 10 is an example of a computer system 1000 with which embodiments of the present disclosure may be utilized. Computer system 1000 may represent or form a part of an EMR fraud detection system (e.g., EMR fraud detection system 500) that is coupled to or integrated within an EMR system (e.g., EMR system 100).

Embodiments of the present disclosure include various steps, which have been described in detail above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 1000 includes a bus 1030, a processor 1005, communication port 1010, a main memory 1015, a removable storage media 1040, a read only memory 1020 and a mass storage 1025. A person skilled in the art will appreciate that computer system 1000 may include more than one processor and communication ports.

Examples of processor 1005 include, but are not limited to, an Intel® Itanium® or Itanium 2 processor(s), or AMD®, Opteron® or Athlon MP® processor(s), Motorola® lines of processors, FortiSOC™ system on a chip processors or other future processors. Processor 1005 may include various modules associated with monitoring unit as described in FIGS. 2-4. Communication port 1010 can be any of an RS-232 port for use with a modem based dialup connection, a 10/100 Ethernet port, a Gigabit or 10 Gigabit port using copper or fiber, a serial port, a parallel port, or other existing or future ports. Communication port 1010 may be chosen depending on a network, such a Local Area Network (LAN), Wide Area Network (WAN), a WLAN or any network to which computer system 1000 connects.

Memory 1015 can be Random Access Memory (RAM), or any other dynamic storage device commonly known in the art. Read only memory 1020 can be any static storage device(s) such as, but not limited to, a Programmable Read Only Memory (PROM) chips for storing static information such as start-up or BIOS instructions for processor 1005.

Mass storage 1025 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 1030 communicatively couples processor(s) 1005 with the other memory, storage and communication blocks. Bus 1030 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 1005 to system memory.

Optionally, operator and administrative interfaces, such as a display, keyboard, and a cursor control device, may also be coupled to bus 1030 to support direct operator interaction with computer system 1000. Other operator and administrative interfaces can be provided through network connections connected through communication port 1010.

Removable storage media 1040 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, to avoid obscuring the present invention.

Some portions of the detailed description have been presented in terms of algorithms and symbolic representations of operations on data bits within a computer memory. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “computing”, “comparing”, “determining”, “adjusting”, “applying”, “creating”, “ranking,” “classifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain embodiments of the present invention also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other embodiments will be apparent to those of skill in the art upon reading and understanding the above description. The scope of the invention should therefore be determined with reference to the appended claims, along with the full scope of equivalents to which such claims are entitled.

What is claimed is:

1. A method comprising:
receiving and queuing in real-time onto a message queue implemented by one or more computer systems of an Electronic Medical Record (EMR) fraud and risk mitigation system, activity information as it is posted to a plurality of audit logs of an EMR system, wherein the activity information includes information regarding timing of an access to a database of a plurality of databases of the EMR system, a type of the access and a user initiating the access;
correlating and analyzing in real-time, by one or more analysis models implemented by the one or more computer systems, the activity information by dequeuing the activity information from the message queue and applying configurable rules maintained by a rules engine implemented by the one or more computer systems; and
detecting based on said correlating and analyzing, existence of one or more related events potentially indicative of fraud.

2. The method of claim 1, wherein said correlating and analyzing comprises extracting analytics and statistical data based on a subset of the activity information.

3. The method of claim 1, wherein the message queue is configured to enable processing of activity information in proper temporal order.

4. The method of claim 1, wherein said at least one rule is defined in real-time based on said one or more events associated with said at least one audit log.

5. The method of claim 2, further comprising automatically defining at least one rule of the configurable rules maintained by the rules engine based on the extracted analytics and statistical data.

6. The method of claim 1, further comprising aggregating information regarding one or more observed events to generate analytics and statistical data.

7. The method of claim 1, further comprising defining at least one rule of the configurable rules maintained by the rules engine based on a learning based anomaly detection model that is configured to dynamically determine one or more thresholds of acceptable behavior for particular activities in relation to the EMR system.

8. The method of claim 1, further comprising defining at least one rule of the configurable rules maintained by the rules engine based on one or a combination of a predictive model and a social network analysis model.

9. An Electronic Medical Record (EMR) fraud and risk mitigation system comprising:
a message queue implemented by one or more computer systems configured to receive and queue in real-time activity information as it is posted to a plurality of audit logs of an EMR system;
a rules engine implemented by the one or more computer systems configured to create, store, and manage a plurality of rules;
a processing engine implemented by the one or more computer systems configured to detect one or more related events potentially indicative of fraud by retrieving activity information form the message queue, correlating the activity information and applying one or more of the rules of the plurality of rules to the correlated activity information.

10. The system of claim 9, further comprising an analytics engine configured to store analytics and statistical data relating to the activity information.

11. The system of claim 9, wherein said message queue is configured to enable processing of activity information in proper temporal order.

12. The system of claim 9, wherein at least one of the plurality of rules is defined in real-time based on the one or more related events.

13. The system of claim 10, wherein at least one of the plurality of rules is automatically defined based on the analytics and statistical.

14. The system of claim 9, wherein at least one of the plurality of rules is defined based on a learning based anomaly detection model that is configured to dynamically determine one or more thresholds of acceptable behavior for particular activities in relation to the EMR system.

15. The system of claim 9, wherein at least one rule of the plurality of rules is defined based on one or a combination of a predictive model and a social network analysis model.
